(19) United States
(12) Patent Application Publication
(10) Pub. No.: US 2013/0316035 A1
(43) Pub. Date: Nov. 28, 2013

(54) PRESS MOLDING SYSTEM

(71) Applicant: Shigeru Nishiyama, Toyota-shi (JP)

(72) Inventor: Shigeru Nishiyama, Toyota-shi (JP)

(73) Assignee: KOJIMA PRESS INDUSTRY CO., LTD., Toyota-shi, Aichi (JP)

(21) Appl. No.: 13/977,632

(22) PCT Filed: Dec. 28, 2010
(86) PCT No.: PCT/JP2010/073728

§ 371 Date: Jul. 26, 2013

(51) Int. Cl. B29C 33/00

(52) U.S. Cl. CPC B29C 33/0088
USPC 425/150

(57) ABSTRACT

A press molding system (1) may include a first press molding apparatus (2) and a second press molding apparatus (3). When a material (M3) molded by the first press molding apparatus (2) is conveyed to the second press molding apparatus (3), an orientation of the material may be changed simultaneously with the conveyance from an orientation taken when conveyed out of the first press molding apparatus (2) to a desired orientation for the second press molding apparatus (3).

### TECHNICAL FIELD

The present invention relates to a press molding system.

### BACKGROUND ART

As shown, for example, in Japanese Laid-Open Patent Publication No. 06-31498, there has been disclosed a press molding apparatus in which a material such as a metal plate is held between a pair of dies (an upper die and a lower die) and clamped (press-worked) between them, whereby it is possible to mold a workpiece having a desired shape. This easily enables mass production of workpieces.

However, in the technique as disclosed in Japanese Laid-Open Patent Publication No. 06-31498, it is necessary to provide a plurality of press molding apparatuses when performing a plurality of press working operations (e.g., bending and stamping) on a single material. Thus, it is necessary to provide drive sources for press working in a number corresponding to the number of press molding apparatuses, resulting in a rather low energy efficiency.

There has been a need in the art for a press molding system that can perform press working with high energy efficiency even when performing a plurality of press working operations on a single material.

### SUMMARY OF THE INVENTION

In one aspect according to the present teachings, a press molding system may include a first press molding apparatus and a second press molding apparatus and may be configured such that, when a material molded by the first press molding apparatus is conveyed to the second press molding apparatus, an orientation of the material is changed simultaneously with the conveyance from an orientation taken when conveyed out of the first press molding apparatus to a desired orientation for the second press molding apparatus.

With this construction, even when a plurality of press working operations are to be performed on a single material, it is possible to perform press working with high energy efficiency. Further, with this construction, when a material molded by the first press molding apparatus is conveyed to the second press molding apparatus, an orientation of the material is changed simultaneously with the conveyance from an orientation taken when conveyed out of the first press molding apparatus to a desired orientation for the second press molding apparatus. Therefore, it is not necessary to provide a separate process for changing the orientation when the material molded by the first press molding apparatus is conveyed to the second press molding apparatus.

### BRIEF DESCRIPTION OF THE DRAWINGS

FIG. 1 is an overall view illustrating the construction of a press molding system according to an embodiment of the present invention.

FIG. 2 is an enlarged view of a first vertical three-stage press apparatus as shown in FIG. 1 in a die-open state.

FIGS. 3(A) and 3(B) are vertical sectional views illustrating in detail the assembly structure for a first lower die and a first driven die plate of FIG. 2.

FIGS. 4(A) and 4(B) are vertical sectional views illustrating in detail the assembly structure for a first upper die and a driving die plate of FIG. 2.

FIG. 5 is a front view of the first vertical three-stage press apparatus of FIG. 2, illustrating it in a die-open state.

### DETAILED DESCRIPTION OF THE INVENTION

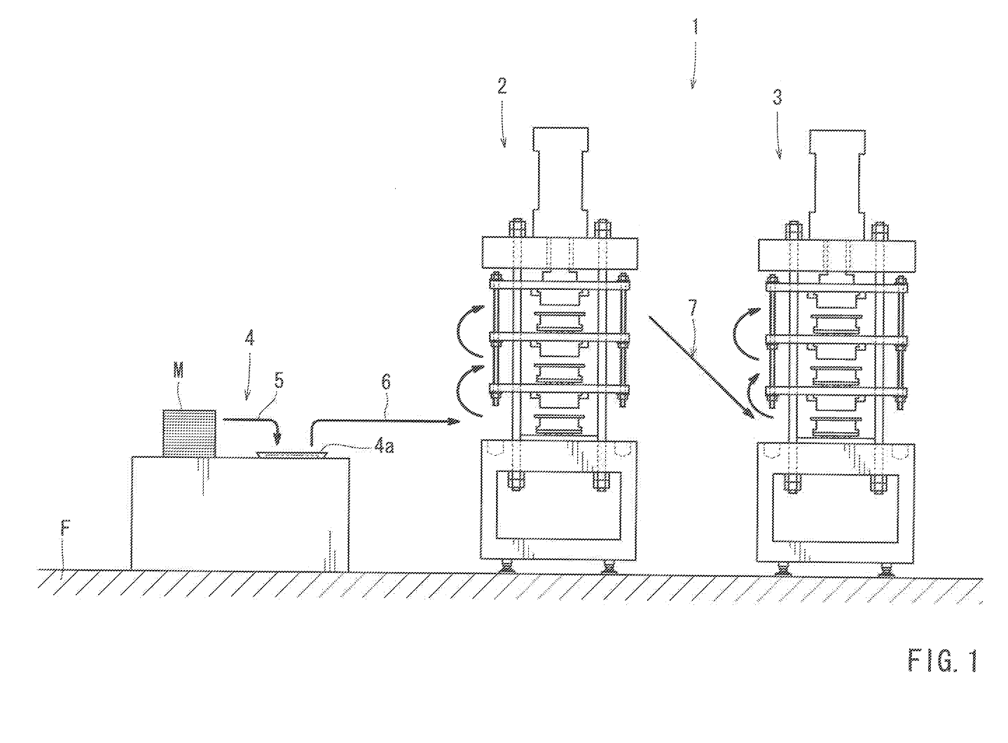

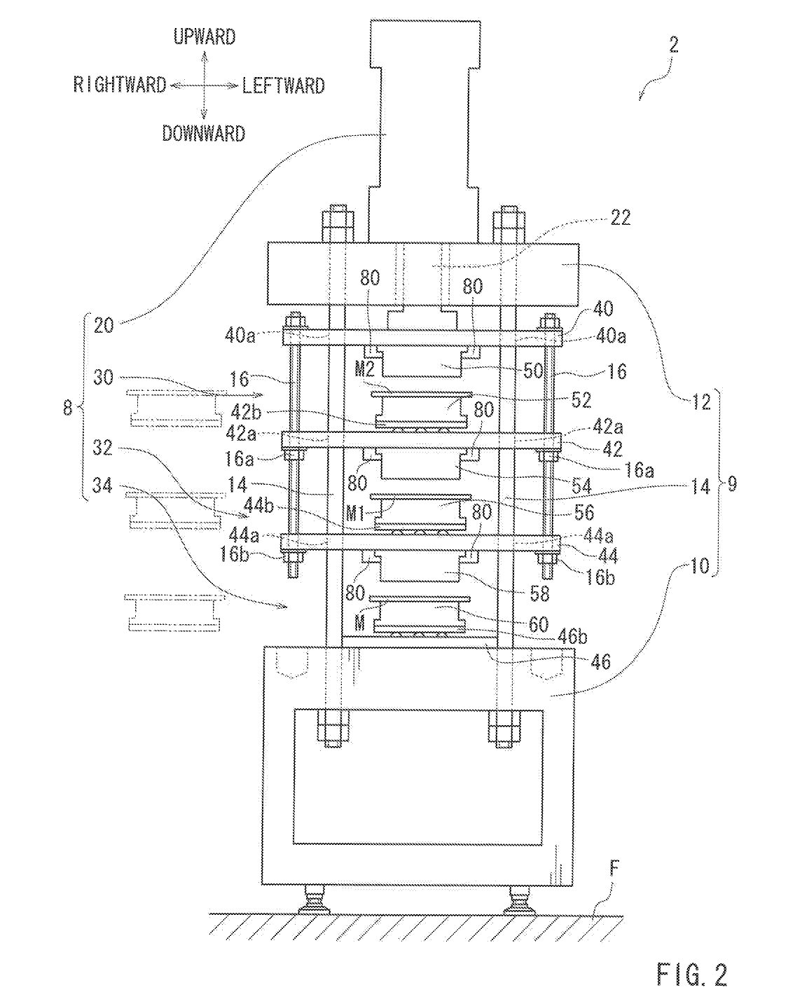

In the following, an embodiment of the present invention will be described with reference to FIGS. 1 through 5. In the following description, there will be described, as an example of a “press molding apparatus,” a “vertical three-stage press apparatus (a first vertical three-stage press apparatus 2 and a second vertical three-stage press apparatus 3).” In the following description, the upper, lower, front, rear, left, and right sides correspond to the upper, lower, front, rear, left, and right sides when the vertical three-stage press apparatuses 2 and 3 are used as a reference. That is, in the case, for example, of FIG. 2, the upper, lower, front, rear, left, and right sides as seen in the plane of the sheet will be regarded as the upper, lower, front, rear, left, and right sides as referred to in the present description.

First, referring to FIG. 1, the overall construction of a press molding system 1 according to an embodiment of the present invention will be described. The press molding system 1 may generally include a first vertical three-stage press apparatus 2, a second vertical three-stage press apparatus 3, a stocker apparatus 4, and a conveyance apparatus 7. In the following, these apparatuses 2, 3, 4, and 7 will be described individually.

First, the first vertical three-stage press apparatus 2 will be described with reference to FIGS. 2 through 5. The second vertical three-stage press apparatus 3 may be of the same construction as the first vertical three-stage press apparatus 2 except that the configurations of their dies 50, 52, 54, 56, 58, and 60 differ. Therefore, the first vertical three-stage press apparatus 2 will be described, while the description of the second vertical three-stage press apparatus 3 will be omitted.

As shown in FIG. 2, the first vertical three-stage press apparatus 2 may be constituted mainly of a frame portion 8 constituting the framework thereof, and a press portion 9 for molding materials M, M1, and M2. In the following, the frame portion 8 and the press portion 9 will be described individually.

First, the frame portion 8 will be described. This frame portion 8 is constituted by a lower frame 10 installed on a floor F, an upper frame 12 opposite the lower frame 10, and four guide shafts 14 connecting the respective four corners of the opposing surfaces of the two frames 10 and 12 (the upper surface of the lower frame 10 and the lower surface of the upper frame 12) so as to be bridged between them. The frame portion 8 is constructed in this way.

Next, the press portion 9 will be described. The press portion 9 is constituted by a press cylinder 20 serving as a drive source, and three molding dies 30, 32, and 34 (hereinafter referred to as a “first molding die 30,” a “second molding die 32,” and a “third molding die 34”) for molding materials M, M1, and M2 through die-closing and die-opening by telescopic motion of the press cylinder 20. The press cylinder 20 and the molding dies 30, 32, and 34 will be described individually.

First, the press cylinder 20 will be described. This press cylinder 20 is fastened to the upper surface of the upper frame 12 such that a cylinder rod 22 thereof passes through the upper frame 20 in the thickness direction thereof. This press cylinder 20 is constructed so as to be capable of causing the cylinder rod 22 thereof to make telescopic motion by hydraulic pressure from the outside. The press cylinder 20 is constructed in this way.

Next, the first molding die 30 will be described. This first molding die 30 is constituted by a driving die plate 40, a first driven die plate 42 paired with the driving die plate 40, a first upper die 50, and a first lower die 52 paired with the first upper die 50. The driving die plate 40, the first driven die plate 42, the first upper die 50, and the first lower die 52 will be described individually.

First, the driving die plate 40 will be described. This driving die plate 40 is a base plate for mounting the first upper die 50 that will be hereinafter described. The driving die plate 40 has at its four corners guide holes 40a allowing insertion of the above-mentioned four guide shafts 14.

The diameter of the guide holes 40a set to be sufficiently larger than the outer diameter of the shafts 14 to be inserted into the guide holes 40a. Thus, even when deflection is generated in the guide shafts 14 due to a large load applied to the lower frame 10 from the upper frame 12, such deflection can be absorbed by the guide holes 40a. Accordingly, it is possible for the guide shafts 14 to guide the guide holes 40a, so that it possible to smoothly raise and lower the driving die plate 40.

And, the driving die plate 40 is fastened to the leading end of the cylinder rod 22 of the press cylinder 20 mentioned above, with the guide shafts 14 inserted into the guide holes 40a. As a result, it is possible to raise and lower the driving die plate 40 smoothly without involving any tilting or rattling when causing the cylinder rod 22 to make telescopic motion. The driving die plate 40 may be made, for example, of raw iron material. This may be also applied to the first driven die plate 42, a second driven die plate 44, and a stationary die plate 46 that will be hereinafter described.

Next, the first driven die plate 42 will be described. This first driven die plate 42 is a base plate for mounting the first lower die 52 that will be hereinafter described. Like the above-described driving die plate 40, the first driven die plate 42 also has at its four corners guide holes 42a allowing insertion of the four guide shafts 14.

Like the diameter of the guide holes 40a described above, the diameter of the guide holes 42a is also set to be sufficiently larger than the outer diameter of the guide shafts 14 inserted into the guide holes 42a. Therefore, as in the case of the driving die plate 40 described above, even when deflection is generated in the guide shafts 14 due to a large load applied from the upper frame 12 to the lower frame 10, such deflection can be absorbed by the guide holes 42a. Accordingly, it is possible for the guide shafts 14 to guide the guide holes 42a, so that it is possible to smoothly raise and lower the first driven die plate 42.

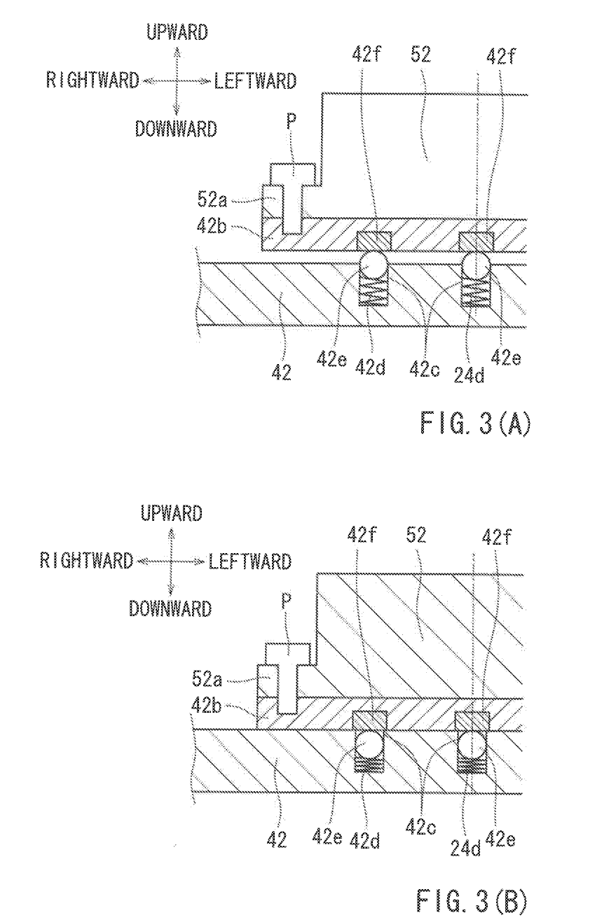

Further, as shown in FIGS. 3(A) and 3(B), at appropriate positions of the upper surface of the first driven die plate 42, there are formed recessed holes 42c. In this embodiment, nine recessed holes 42c in total are formed in three rows and three columns in the left and right direction and the front and rear direction. At the recessed holes 42c, there are arranged spherical bearings 42e through the intermediation of compression springs 42d. The compression springs 42d are set such that, due to their urging forces, a slider 42b is raised from the upper surface of the first driven die plate 42 together with the first lower die 52 when the first upper die 50 and the first lower die 52 are in the die-open state (see FIG. 3(A)).

In addition, the compression springs 42d are set such that, when the first upper die 50 and the first lower die 52 are placed in the die-closing state, the slider 42b is pressed against the upper surface of the first driven die plate 42 together with the first lower die 52 against the urging force of the compression springs 42d (see FIG. 3(B)). Due to the bearings 42e, when the slider 42b slides with respect to the first driven die plate 42, the sliding movement can be performed smoothly. This is also applied to the second driven die plate 44 and the stationary die plate 46 that will be hereinafter described.

And, the first driven die plate 42 is suspended from the driving die plate 40 via four suspension supports 16, with the guide shafts 14 being inserted into the guide holes 42a like the above-described driving die plate 40 (see FIG. 2). More specifically, the first die plate 42 is suspended from the driving die plate 40 such that its downward movement with respect to the driving die plate 40 is restricted at the position where the two dies 50 and 52 are in the die-open state.

This restriction in downward movement may be effected by four first stoppers 16a respectively mounted to the four suspension supports so as to allow adjustment in height. As a result, when the driving die plate 40 is raised or lowered, it is possible to raise or lower the first driven die plate 42 while guiding the guide holes 42a at the four corners by the four guide shafts 14.

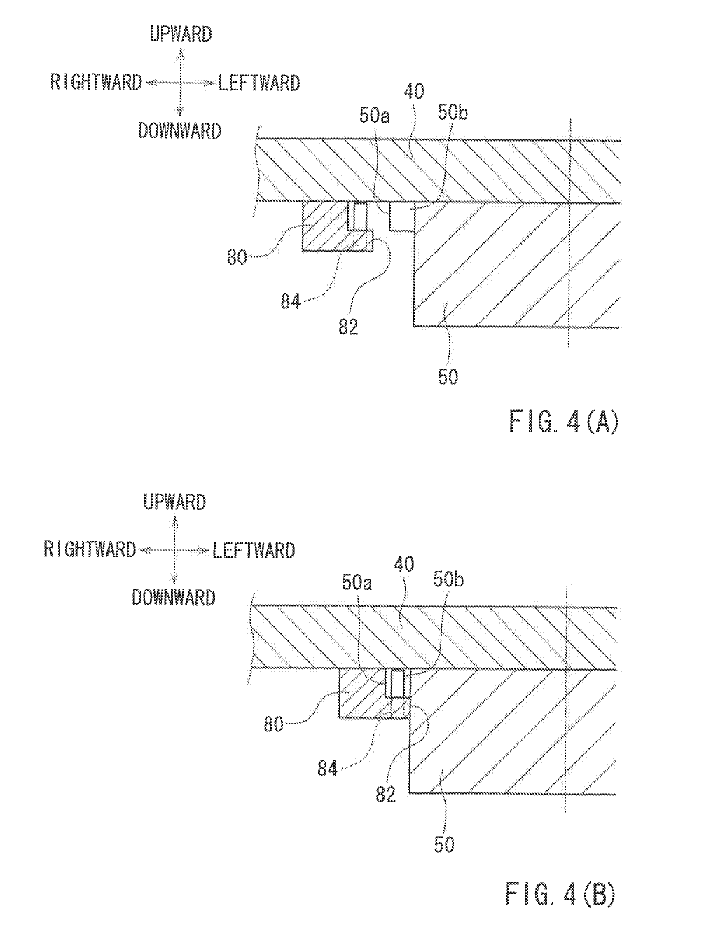

Next, the first upper die 50 will be described. This first upper die 50 is a die for molding the material M before being molded into the material M1. The first upper die 50 is detachably mounted to the lower surface of the driving die plate 40 via a pair of right and left support blocks 80. In the following, this mounting structure will be described in detail with reference to FIG. 4. This mounting structure is of a symmetrical structure, so that only the right-hand side mounting structure (the left-hand side mounting structure when seen in the direction towards the sheet of FIGS. 4(A) and 4(B)) will be described, and the left-hand side mounting structure (the left-hand side mounting structure when seen in the direction towards the sheet of FIGS. 4(A) and 4(B)) will be omitted.

Each support block 80 may be a block formed in a substantially L-shape in front view. The upper surface of the support block 80 is mounted to the lower surface of the driving die plate 40 via a well-known slide mechanism (not shown) capable of sliding in the left and right direction. A pin 84 protruding toward the lower surface of the driving die plate 40 may be fastened to the center with respect to the front and rear direction of a protruding portion 82 of the substantially L-shaped configuration of each support block 80.

On the other hand, a flange 50a may be formed at the right-hand side upper edge of the first upper die 50. At the center with respect to the front and rear direction of the flange 50a, there is formed a substantially U-shaped recessed groove 50b into which the above-mentioned pin 84 can be fitted. The protruding portion 82 of the support block 80 and the flange 50a of the above-mentioned first upper die 50 are formed so as to coincide with each other in height.

And, the first upper die 50 is set at a predetermined position on the lower surface of the driving die plate 40, and while maintaining this set state, the support block 80 is caused to slide such that the pin 84 is fitted into the recessed groove 50b (i.e., the support block 80 is slid so as to effect transition from the state shown in FIG. 4(A) to the state shown in FIG. 4(B)). Then, since the pin 84 and the recessed groove 50b are formed such that their fit-engagement is tight, the first upper die 50 is mounted to the support block 80 due to this tight fit-engagement.

Since the support block 80 is mounted to the driving die plate 40 as described above, it is possible, as a result of this mounting, to mount the first upper die 50 to the lower surface of the driving die plate 40 (see FIG. 4(B)).

When the above-mentioned sliding of the support block 80 is restored, it is possible to detach the first upper die 50 from the lower surface of the driving die plate 40 (see FIG. 4(A)). In this way, the first upper die 50 is detachably mounted to the lower surface of the driving die plate 40 via the pair of right and left support blocks 80.

Finally, referring back to FIGS. 3(A) and 3(B), the first lower die 52 will be described. The first lower die 52 is formed so as to be paired with the above-described first upper die 50; it is a die for molding the material M before being molded into the material M1. The first lower die 52 is detachably mounted to the upper surface of the slider 42b by inserting pins P into a flange 52 thereof.

Due to the slider 42b, it is possible to slide the first lower die 52 to a position deviated from the die-closing/die-open position with respect to the first driven die plate 42 (the position indicated by the phantom line in FIG. 2). With this sliding ability, it is easier to covey the material M3 molded by the die-closing at the first molding die 30 to the next process, and to receive the material M2 molded through the die-closing at the second molding die 32.

Inserts 42f may be detachably inserted into portions of the lower surface of the slider 42b which come into contact with the bearings 42e. The inserts 42f are endowed with wear resistance; they may be formed, for example, through nitrided quenching of S45C. This is also applied to the sliders 44b and 46b that will be hereinafter described.

The first molding die 30 may be constituted by the driving die plate 40, the first driven die plate 42, the first upper die 50, and the first lower die 52.

Next, the second molding die 32 will be described. The second molding die 30 may be constituted by the first driven die plate 42, a second driven die plate 42 paired with the first driven die plate 42, a second upper die 54, and a second lower die 56 paired with the second upper die 54. In the following, the second driven die plate 44, the second upper die 54, and the second lower die 56 will be described individually.

The first driven die plate 42 may also serve as a component of the above-described first molding die 30. Because the first driven die plate 42 has already been described in connection with the above-mentioned first die 30, a detailed description thereof will be omitted.

First, the second driven die plate 44 will be described. This second driven die plate 44 is a base plate for mounting the second lower die 56 that will be described later. As in the case of the driving die plate 40 and the first driven die plate 42 described above, the second driven die plate 44 also has at its four corners four guide holes 44a allowing insertion of four guide shafts 14.

Like the diameter of the guide holes 40a and 42a described above, the diameter of the guide holes 44a may be set so as to be sufficiently larger than the outer diameter of the guide shafts 14 to be inserted into the guide holes 44a. As a result, as in the case of the driving die plate 40 and the first driven die plate 42, even when deflection is generated in the guide shafts 14 due to a large load applied from the upper frame 12 to the lower frame 10, such deflection can be absorbed by the guide holes 44a. Accordingly, it is possible for the guide holes 44a to be respectively guided by the guide shafts 14, so that it is possible to raise and lower the second driven die plate 44 smoothly.

And, like the first driven die plate 42 described above, the second driven die plate 44 is also suspended from the driving die plate 40 via four suspension supports 16 suspended from the driving die plate 40, with the guide shafts 14 inserted into the guide holes 44a. More specifically, at the position where the two dies 54 and 56 that will be described below are in the die-open state, the second driven die plate 44 is suspended from the driving die plate 40 so as to be restricted in its downward movement with respect to the first driven die plate 42.

As in the case of the above-described four first stoppers 16a, this restriction in the downward movement may be effected by four second stoppers 16b that are mounted to the four suspension supports so as to allow adjustment in height. As a result, when the driving die plate 40 is raised or lowered, it is possible to raise or lower the second driven die plate 44 while guiding the guide holes 44a at the four corners by the four guide shafts 14.

Next, the second upper die 54 will be described. Like the first upper die 50 described above, the second upper die 54 is a die for molding the material M1 molded by the first molding die 30 into the second material M2. Like the first upper die 50 described above, the second upper die 54 is also detachably mounted to the lower surface of the first driven die plate 42 via the pair of right and left support blocks 80. The mounting structure is similar to the above-described structure for mounting the first upper die 50 to the lower surface of the driving die plate 40, so a detailed description thereof will be left out.

Finally, the second lower die 56 will be described. This second lower die 56 is formed so as to be paired with the first upper die 54 described above; it is a die for molding the material M1 molded at the first molding die 30 into the material M2. Like the above-described first lower die 52, the second lower die 56 is detachably mounted to the upper surface of the slider 44b by inserting pins (not shown) into a flange (not shown) thereof.

The slider 44b may be formed in a fashion similar to the slider 42b. As a result, as in the case of the first lower die 52, it is possible to cause the second lower die 56 to slide to a position deviated from the die-closing/die-open position with respect to the second driven die plate 44 (the position indicated by the phantom line in FIG. 2).

The second molding die 32 may be constituted by the first driven die plate 42, the second driven die plate 44, the second upper die 54, and the second lower die 56.

Finally, the third molding die 34 will be described. The third molding die 34 may be constituted by the second driven die plate 44, a stationary die plate 46 paired with the second driven die plate 44, a third upper die 58, and a third lower die 60 paired with the third upper die 58. In the following, the stationary die plate 46, the third upper die 58, and the third lower die 60 will be described individually.

The second driven die plate 44 also serves as a component of the above-mentioned second molding die 32. The second driven die plate 44 has already been described in connection with the description of the second molding die 32, so a detailed description thereof will be omitted.

First, the stationary die plate 46 will be described. The stationary die plate 46 is a base plate for mounting the third lower die 60 that will be described later. And, the stationary die plate 46 is fastened to the upper surface of the lower frame 10.

Next, the third upper die 58 will be described. Like the first upper die 50 and the second upper die 54 described above, the third upper die 58 is a die for molding the material M3 from the material M2 formed at the second molding die 32. Like the first upper die 50 and the second upper die 54 described above, this third upper die 58 is also detachably mounted to the lower surface of the second driven die plate 44 via the pair of right and left support blocks 80. The mounting structure is the same as the structure for mounting the first upper die 50 to the lower surface of the driving die plate 40 and as the structure for mounting the second upper die 54 to the lower surface of the first driven die plate 42, so a detailed description thereof will be omitted.

Finally, the third lower die 60 will be described. Like the first lower die 52 and the second lower die 56 described above, the third lower die 60 is a die for molding the material M2 molded at the second molding die 32 into the material M3. Like the first lower die 52 and the second lower die 56 described above, the third lower die 60 is also detachably mounted to the upper surface of a slider 46b by inserting pins (not shown) into a flange (not shown) thereof.

This slider 46b may be formed in a fashion similar to the sliders 42b and 44b described above. As a result, as in the case of the first lower die 52 and the second lower die 56, it is possible to cause the third lower die 60 to a position (the position indicated by the phantom line in FIG. 2) deviated from the die-closing/die-open position with respect to the stationary die plate 46.

The third molding die 34 may be constituted by the second driven die plate 44, the stationary die plate 46, the third upper die 58, and the third lower die 60. The press portion 9 is constructed in this way.

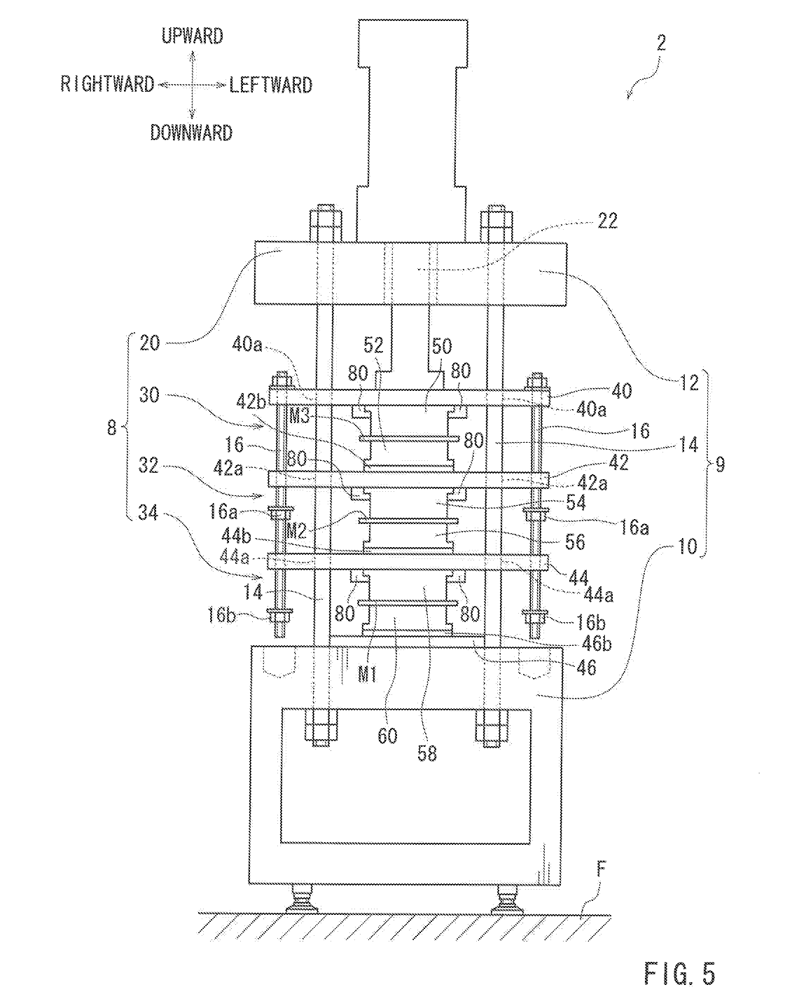

Subsequently, referring to FIGS. 2 and 5, the operation of the first vertical three-stage press apparatus 2, which is constituted by the frame portion 8 and the press portion 9 described above, will be described. First, the description will be started from the state in which the dies 50, 52, 54, 56, 58, and 60 are in the die-open state as shown in FIG. 2. In this state, the operation of setting the materials M, M1, and M2 in the lower dies 52, 56, and 60, respectively, is performed. This setting may be performed by arms (not shown).

Next, the operation of extending (pushing) the cylinder rod 22 of the press cylinder 20 is performed. As a result, the driving die plate 40, the first driven die plate 42, and the second driven die plate 44 descend toward the side of the lower frame 10.

During the operation, the first driven die plate 42 descends toward the side of the lower frame 10 while maintaining a distance between itself and the driving die plate 40 by the four first stoppers 16a. Further, during the operation, the second driven die plate 44 also descends toward the lower frame 10 side while maintaining a distance between itself and the first driven die plate 42 by the four second stoppers 16b.

Then, first, the third upper die 58 and the third lower die 60 start to come into contact with each other, with the material M being held between them. Subsequently, as the driving die plate 40 and the first driven die plate 42 descend, the second upper die 54 and the second lower die 56 start to come into contact with each other, with the material M1 being held between them. As the driving die plate 40 further descends, the first upper die 50 and the first lower die 52 start to come into contact with each other, with the material M2 being held between them.

As the driving die plate 40 further descends, die-closing is effected between these three pairs of dies (between the first upper die 50 and the second lower die 52, between the second upper die 54 and the second lower die 56, and between the third upper die 58 and the third lower die 60). As a result, the materials M3, M2, and M1 are molded respectively from the materials M2, M1, and M (see FIG. 5).

When this molding operation is completed, the operation of contracting (retracting) the cylinder rod 22 of the press cylinder 20 is performed. Therefore, the driving die plate 40 ascends toward the side of the upper frame 12. As a result, die-opening is effected between the first upper die 50 and the first lower die 52.

As the driving die plate 40 further ascends, the four first stoppers 16a interfere with the first driven die plate 42, so that, from this onward, as the driving die plate 40 ascends, the first driven die plate 42 also ascends. As a result, die-opening is effected between the second upper die 54 and the second lower die 56.

As the driving die plate 40 further ascends, the four second stoppers 16b interfere with the second driven die plate 44, so that, from this onward, as the driving die plate 40 ascends, the second driven die plate 44 also ascends. As a result, die-opening is effected between the third upper die 56 and the third lower die 60.

When the contraction of the cylinder rod 22 of the press cylinder 20 is completed, the die-opening of these three pairs of dies (die-opening between the first upper die 50 and the second lower die 52, between the second upper die 54 ad the second lower die 56, and between the third upper die 58 and the third lower die 60) is also completed. In this way, one cycle of the operation of the vertical three-stage press apparatus 1 is completed.

After that, the sliders 42b, 44b, and 46b are caused to slide to extract the materials M3, M2, and M1 from the lower dies 52, 56, and 60 via arms (not shown), and the extracted materials M3, M2, and M1 are moved to the next process (in this embodiment, to the third lower die 60 of the second vertical three-stage press apparatus 3, the first lower die 52 of the first vertical three-stage press apparatus 2, and the second lower die 56 of the first vertical three-stage press apparatus 2). At that time, the material M is newly set in the third lower die 60 of the first vertical three-stage press apparatus 2. And, the sliders 42b, 44b, and 46b are caused to slide to the state prior to the sliding. From this onward, these operations are repeated. The first vertical three-stage press apparatus 2 is constructed in this way.

Next, referring back to FIG. 1, the stocker apparatus 4 will be described. This stocker apparatus 4 may be an apparatus for conveying the stocked material M to the third lower die 60 of the first vertical three-stage press apparatus 2. Further, the stocker apparatus 4 may be provided with a tray 4a for applying oil to the material M at a desired position in the course of the conveyance. Inside the tray 4a, there is provided a sponge soaked with oil so as to be ready for the arrival of the material M.

Thus, when the material M is conveyed into this tray 4a, it is possible to apply oil to a desired position of this conveyed material M. Due to this oil, even if, for example, a molding step such as a drawing step is to be performed in both of the vertical three-stage press apparatuses 2 and 3, such a molding step can be easily performed. To covey the stocked material M to the tray 4a, a first arm 5, for example, is used, and to convey the material M on the tray 4a to the third lower die 60 of the first vertical three-stage press apparatus 2, a second arm 6, for example, is used. The stocker apparatus 4 is constructed in this way.

Finally, the conveyance apparatus 7 will be described. This conveyance apparatus 7, may be an apparatus for conveying the material M3 molded at the first molding die 30 of the first vertical three-stage press apparatus 2 to the third lower die 60 of the second vertical three-stage press apparatus 3 for a further molding operation. The conveyance apparatus 7 may be endowed with not only the function of conveying the material M3 (conveying function) but also the function of changing the orientation of the material M3 simultaneously with the conveyance (orientation changing function). The conveyance apparatus 7 is constructed in this way.

The press molding system 1 may be constituted by the first vertical three-stage press apparatus 2, the second vertical three-stage press apparatus 3, the stocker apparatus 4, and the conveyance apparatus 7.

Next, a series of operations performed by the press molding system 1 will be described. First, the material M stocked in the stocker apparatus 4 is conveyed to the first vertical three-stage press apparatus 2 by the two arms 5 and 6, and is set in the third lower die 60 of the third molding die 34. As described above, at this time, oil has been applied to a desired position on the material M.

Next, the material M thus set is molded into the material M1 by the third molding die 34, and is then set in the second lower die 56 of the second molding die 32 by the arm (not shown). Next, the material M1 thus set is molded into the material M2 by the second molding die 32, and is then set in the first lower die 52 of the first molding die 30 by the arm (not shown).

Next, the material M2 thus set is molded into the material M3 by the first molding die 30, and is then set in the third lower die 60 of the third molding die 34 of the second vertical three-stage press apparatus 3 by the conveyance apparatus 7. As already described, at this time, due to the orientation changing function with which the conveyance apparatus 7 is endowed, the material M3 is conveyed such that it is oriented in a desired direction for the second vertical three-stage press apparatus 3.

Next, the material M3 thus set is formed into a material M4 (not shown) by the third molding die 34, and is then set in the second lower die 56 of the second molding die 32 by the arm (not shown). Next, the material M4 thus set is molded into a material M5 (not shown) by the second molding die 32, and is then set in the first lower die 52 of the first molding die 30 by the arm (not shown).

Finally, the material M5 thus set is molded into a workpiece (a completed product not shown) by the first molding die 30, and is then extracted by the arm (not shown). When this molding step is, for example, a stamping (cutting-off) step for stamping the workpiece out of the material M5, another component different from this workpiece may also be stamped out of a portion of the material M5, which is to be scrapped (residual material). As a result, it is possible to immediately utilize the scrap effectively. In this way, the workpiece is completed from the material M through six molding processes.

In the operation described above, the material M set in the third lower die 60 of the third molding die 34 of the first vertical three-stage press apparatus 2 is molded into the material M1 by the third molding die 34, and is then set in the second lower die 56 of the second molding die 32 by the arm (not shown); at this time, a new material M has been set in the third lower die 60 of the third molding die 34. And, this setting is repeated.

The press molding system 1 according to the embodiment of the present invention is constructed as described above. With this construction, when a material M3 molded by the first press molding apparatus 2 is conveyed to the second press molding apparatus 3, the orientation of the material M3 is changed simultaneously with the conveyance from an orientation taken when conveyed out of the first press molding apparatus 2 to a desired orientation for the second press molding apparatus 3. Therefore, it is not necessary to provide a separate process for changing the orientation when the material M3 molded by the first press molding apparatus 2 is conveyed to the second press molding apparatus 3.

The above description has only been given as an embodiment of the present invention, and does not imply that the present invention is to be limited thereto.

In the embodiment described above, the press cylinder 20 is fastened to the side of the upper frame 12 (so as to press downwards from above). However, this should not be construed restrictively; it is also possible for the press cylinder 20 to be fastened to the side of the lower frame 10 (so as to press upwards from below).

Further, in the present embodiment, the vertical three-stage press apparatuses 2 and 3 have been described as the press molding apparatus. However, this should not be construed restrictively; there are no limitations regarding the number of stages so long as there are provided with a plurality of stages.

Further, the present invention may include not only the configuration of the above-described embodiment but also the following configuration: “A press molding apparatus comprising pairs of upper and lower dies arranged in series in the same direction as a die-closing/die-opening direction.” This makes it possible to perform press working with satisfactory energy efficiency even when a plurality of press working operations are to be performed on a single material.

1. A press molding system comprising a first press molding apparatus and a second press molding apparatus, wherein when a material molded by the first press molding apparatus is conveyed to the second press molding apparatus, an orientation of the material is changed simultaneously with the conveyance from an orientation taken when conveyed out of the first press molding apparatus to a desired orientation for the second press molding apparatus.
